(19) United States
(12) Patent Application Publication
(10) Pub. No.: US 2007/0239502 A1
(43) Pub. Date: Oct. 11, 2007

(54) AUTOMATED RECALL MANAGEMENT SYSTEM FOR ENTERPRISE MANAGEMENT APPLICATIONS

(75) Inventor: Suresh Rangaswamy BABU, Los Altos, CA (US)

Correspondence Address: KENYON & KENYON LLP, RIVERPARK TOWERS, SUITE 600, 333 W. SAN CARLOS ST., SAN JOSE, CA, 95110, US

(73) Assignee: SAP AG, Walldorf (DE)

(21) Appl. No.: 11/750,587

(22) Filed: May 18, 2007

Related U.S. Application Data
(62) Division of application No. 10/776,619, filed on Feb. 12, 2004.
(60) Provisional application No. 60/483,903, filed on Jul. 2, 2003.

(51) Int. Cl. G06F 17/00

(52) U.S. Cl. 705/7

(57) ABSTRACT

A computerized recall management tool permits an organization to recognize and proactively manage events that can indicate a need to initiate a product recall. Product performance data often is made available to an organization through very diverse communication channels, including from customers, distributors, suppliers, governmental or industry agencies in addition to its internal manufacturing and testing sources. The recall management tool may include modules to recognize patterns of product defects from product performance data, to model an extent to which a product defect may proliferate throughout its distributed products, to alert operators when such patterns are detected, to manage regulatory reporting events and other notification milestones and to manage a recall itself.

This application claims the benefit of priority to provisional application Ser. No. 60/483,903, filed Jul. 2, 2003, the disclosure of which is incorporated herein in its entirety.

### BACKGROUND

Product recalls are often an expensive exercise that companies must undertake due to issues of safety of life and the related liabilities. Common consumer experience is littered with examples of product recalls that are mismanaged. Product manufacturers traditionally are slow to respond to data that can suggest that defective products have been distributed within the products' market and should be recalled and often are ill-equipped to gather and organize data in a manner that is sufficient to respond to intense media scrutiny that can arise as a consequence of product performance. Moreover, manufacturers and distributors sometimes attempt to shift blame for performance of defective products on each other rather than remediate the problem. As a result, an inadequate response to release of defective products can destroy years of careful brand-building. By contrast, empirical evidence suggest that a firm can respond proactively in the face of defective products and survive without significant loss of good will.

Even the most well intentioned firm, however, encounters practical difficulties to recognize and respond to market events that warrant a recall. First, the firm may learn of product defects through a variety of different sources, for example, from consumers, service people, distributors and perhaps suppliers. Firms often deploy different groups of people to interface with these different sources, which may consider each product defect in isolation. Such fragmentation of effected partners and firm personnel may cause a firm to be slow to recognize that a product defect warrants a recall. Second, some firms are not institutionally equipped to proactively engage their partners—consumers, distributors, etc.—to notify them of a recall. Thus, firms may encounter these and other logistical hurdles that frustrate the firms' ability to respond proactively and perform a product recall.

What is needed is an effective solution that can predict diffusion patterns, be able to quickly estimate overall costs and damage, and provide the ability to contain the spread of defective products in the first place.

### BRIEF DESCRIPTION OF THE DRAWINGS

FIG. 1 a functional block diagram of a recall management system according to an embodiment of the present invention.

FIG. 2 is a functional block diagram illustrating processes undertaken by an early warning system according to an embodiment of the present invention.

FIG. 3 illustrates an exemplary distribution chain.

FIG. 4 is a functional block diagram of a notification system according to an embodiment of the present invention.

FIG. 5 is a functional block diagram of a recall operations module according to an embodiment of the present invention.

FIG. 6 is a flow diagram illustrating a recall operations method according to an embodiment of the present invention.

FIG. 7 is a flow diagram illustrating a recall operations method according to another embodiment of the present invention.

FIG. 8 is a functional block diagram of a defect resolution monitor according to an embodiment of the present invention.

FIG. 9 is a data flow diagram according to an embodiment of the present invention.

FIG. 10 is a simplified block diagram of a computing system according to an embodiment of the present invention.

### DETAILED DESCRIPTION

Embodiments of the present invention provide a computerized tool, a recall management system, to permit a firm to recognize and proactively manage a product recall. The tool, called a ‘recall management system’ herein, includes modules to recognize patterns of product defects from product performance data, to alert operators when such patterns are detected, to manage regulatory reporting events and other notification milestones and to manage a recall itself.

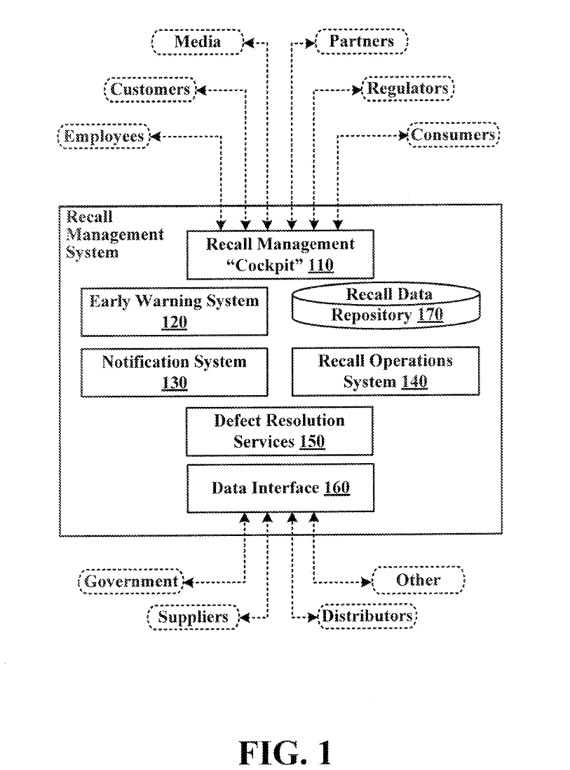

FIG. 1 is a functional block diagram of a recall management system (RMS) according to an embodiment of the present invention. The recall management system 100 may include a recall management ‘cockpit’ 110, an early warning system 120, a notification system 130, a recall operations system 140, a defect resolution services 150 and a data interface system 160. The recall management system 100 also may include a recall data repository 170 to manage data regarding the recall.

The cockpit 110 may govern access to various recall reporting and recall services operations maintained by the RMS 100. As shown in FIG. 1, the cockpit 110 may maintain communications with system users from a variety of different audiences (e.g., employees, customers, media, etc.). Members of one audience may be granted access to different recall services or different reporting mechanisms of the RMS 100 than members of the other audiences. Thus, the cockpit 110 may authenticate system users and govern their access to various facets of the RMS 100.

The early warning and assessment system (EWA) 120 manages data from a variety of sources in a product distributed chain and identifies product defect trends therefrom. The EWA system 120 may manage links to backend system to gather and analyze data. When a potential defect is identified, the EWA system 120 may model potential spread and extent of defective products within its distribution chain.

The notification system 130 may manage compliance with reporting requirements that may be imposed by regulatory sources and others. Thus, it generates reporting data according to templates that are appropriate for the entity that receives them. The notification system 130 also may manage reporting milestones to ensure that the system generates timely reports according to regulatory requirements.

The recall operations system 140 may manage the recall itself. It may provide operational capabilities such as returns management, repair management and service management, which help manage repair or replacement of possibly defective products from various entities in the product distribution chain. The recall operations system 140 also may provide functionality to permit these entities to determine whether the products they hold are subject to the recall and to provide information to integrate them into the recall process.

The defect resolution system 150 may interface with other entities in an enterprise management system (not shown) to remediate problems that are suspected to have caused the detected defect. Thus, the defect resolution system 150 can cause existing processes of the product manufacturer to be amended or enhanced to detect future defects before they enter the product's distribution chain.

The data interface unit 160 may solicit product defect data from various entities in the product's distribution chain. As noted, these can include various members from with the manufacturer's company itself, from suppliers and distributors and from other non-institutional sources such as customers, regulators, consumer product safety organizations, etc.

The recall data repository 170 represents storage to house various data structures being used by the RMS 100 generally. As such, it may include product performance data from which product defects may be identified, recall operations data to monitor performance of the recall, recall performance data that may be call included in recall reports which are published to regulators, the media or other organizations.

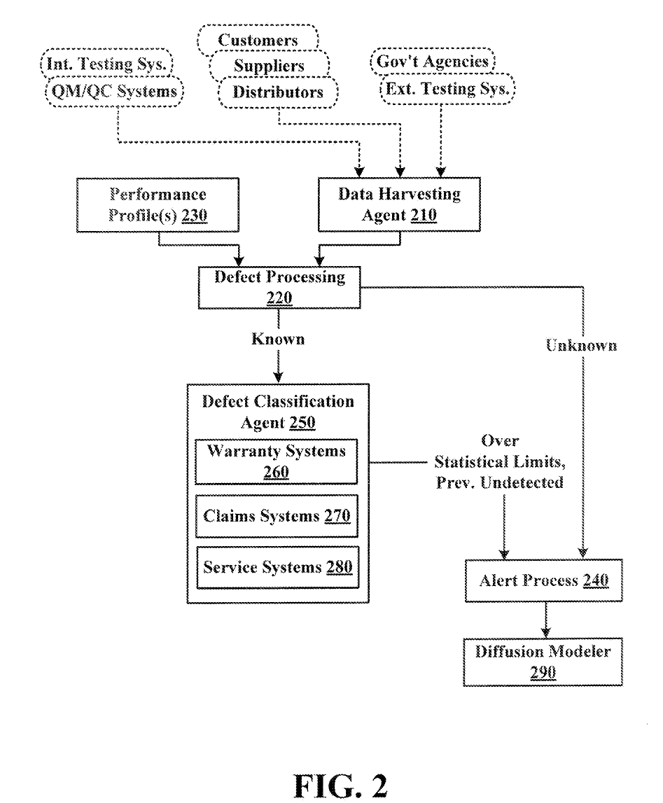

FIG. 2 is a functional block diagram illustrating processes undertaken by the EWA system 200 according to an embodiment of the present invention. There, a data harvesting agent 210 collects product performance data from a variety of sources both internal and external to the company that manufactures the product. Exemplary internal sources include internal testing systems and quality control or quality management systems. Exemplary external sources include data from customers, suppliers and distributors, for example. External sources also may include sources that are not members of the product distribution chain, including possibly governmental agencies or external testing services. The data harvesting agent 210 may collect data from one or more of these sources and populate data structures according to a variety of performance dimensions.

A defect processing agent 220 may compare the actual performance data collected by the harvesting agent 210 with one or more performance profiles 230 for the product. The performance profiles define performance benchmarks for the product; if actual product performance fails below such benchmarks, the product can be considered defective. If the defect processing agent 220 identifies a previously unknown defect, it may engage an alert process 240. If the defect processing agent 220 identifies a known defect, it may engage a defect classification agent 250. In so doing, the defect processing agent 220 may engage one or more product management systems commonly found in enterprise management applications, including warranty management system 260, claims system 270 and service systems 280. The defect classification agent 250 also may determine the extent of the defects within distributed products. For example, warranty systems 260 and the like may indicate the onset of product defects, the geographic distribution of defective products and the like. As a result, the defect classification agent 250 may determine whether the defect type identified is appearing in product line with a frequency that is either within or in excess of statistical limits. If the frequency with which a particular defect occurs in a product line exceeds a predetermined statistical limit, the defect classification agent 250 may engage the alert process 240. Similarly, if the defect classification agent 250 determines that the defect was previously undetected, it may engage the alert process.

According to an embodiment of the present invention, the alert process 240 determines whether the detected defect raises issues sufficient to a merit a recall. Thereafter, the EWA system 200 may perform product diffusion modeling to estimate the extent of the defect in other products that have been manufactured, distributed and/or sold. The EWA 200 may store data representing a distribution chain for the product at issue. Based upon information regarding defects detected for the product, a diffusion modeler 290 may estimate an extent to which defective products have propagated through the distribution chain.

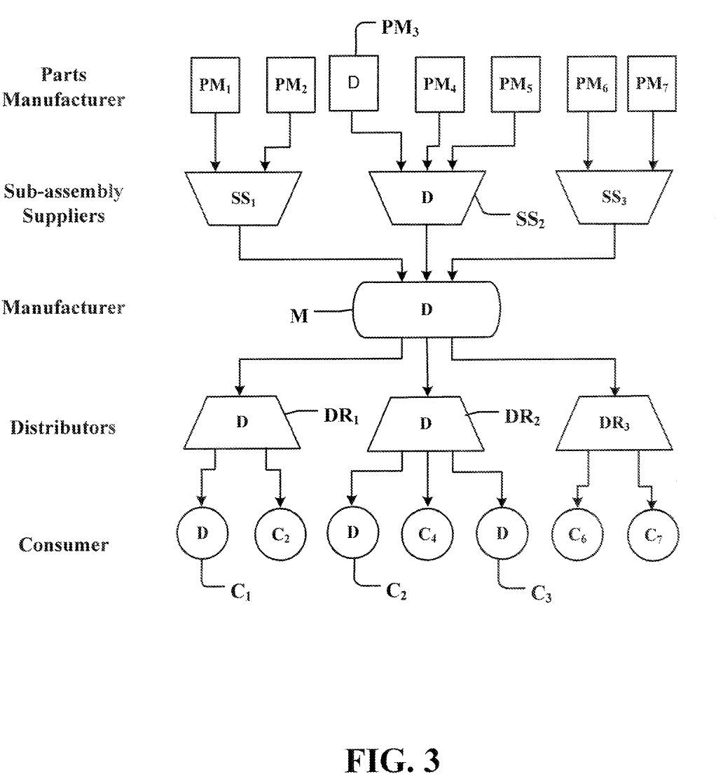

FIG. 3 illustrates an exemplary distribution chain for a hypothetical product. In this example, the distribution chain is composed of many levels including parts manufacturers, sub-assembly manufacturers, manufacturers, distributors and consumers. Although this example illustrates only one layer per level, this need not always be the case. For example, for many products, it is common to provide multiple layers of distributors before a manufactured product reaches an end consumer. The example of FIG. 3, however, is sufficient to illustrate the principles of the distribution modeling process used by the alert process 240.

In the example of FIG. 3, parts manufacturers PM1 and PM2 supply component parts to a sub-assembly supplier SS1. Parts manufacturers PM3-PM5 supply component parts to sub-assembly supplier SS2 and parts manufacturers PM6 and PM7 supply components parts to sub-assembly supplier SS3. Each of the sub-assembly suppliers SS1-SS3 supply sub-assemblies to a manufacturer M. The manufacturers M integrates the sub-assemblies into a completed product and forwards the completed product to distributors DR1-DR3. Distributor DR1 sells products to consumers C1 and C2. Distributor DR2 sells products to consumers C3-C5 and distributor DR3 sells products to consumers C6 and C7.

Consider an example where it is determined that parts manufacturer PM3 likely supplied defective component parts during a three month period. Product diffusion modeling may permit the alert process 240 to estimate the propagation of the defective component parts through its distribution chain. PM3 distributed component parts to sub-assembly supplier SS2. Sub-assemblies that included the defective component may have been supplied to the manufacturer M during some identifiable time period. Products resulting therefrom may have been delivered to distributors DR1 and DR2 and further distributed to consumers C1, C3 and C5. Thus, by modeling flow of products through the distribution chain, the alert process 240 may estimate the actors within the distribution chain that are most likely to have handled (or still hold) defective products.

Distribution modeling can provide information that helps to develop an estimate of the processes that may be required to perform a recall, if one is determined to be appropriate. For example, product diffusion modeling may indicate that defective products are confined to a predetermined geographical region, how many defective products may have been sold, who may have purchased defective products, which distributors may still hold defective products in their inventory and the like. In the foregoing example, distributors DR1 and DR2 and their customers might be clustered in an identifiable region of the United States. Accordingly, diffusion modeling may identify not only the extent to which defective products have proliferated throughout a distribution chain but also may provide a basis from which to plan a recall.

Of course, diffusion modeling merely provides an estimate of product migration that may occur in a distribution chain. The estimate may be refined by information provided by alterative data sources, such as service centers and the like. For example, although consumers may purchase a product from a distributor in one geographic region, they may move products to other geographic regions through normal use of those products. The products may be submitted to repair centers in the different geographic regions, which may log the products by a serial number or other identifier. Some products, in fact, may include RFID devices or auto ID tags that contain electronic serial numbers or other identifying information regarding the product; these identifiers may be linked to auto ID support services, which store product maintenance information regarding the product (essentially a service history). By propagating the serial numbers back to a manufacturer or distributor, the manufacturer/distributor may revise the estimate provided by the diffusion model to obtain a more reliable indicator of product migration. Similarly, exchanges among distributors (for example, a transfer of inventory between two regionally separated distributors) may enhance the diffusion model.

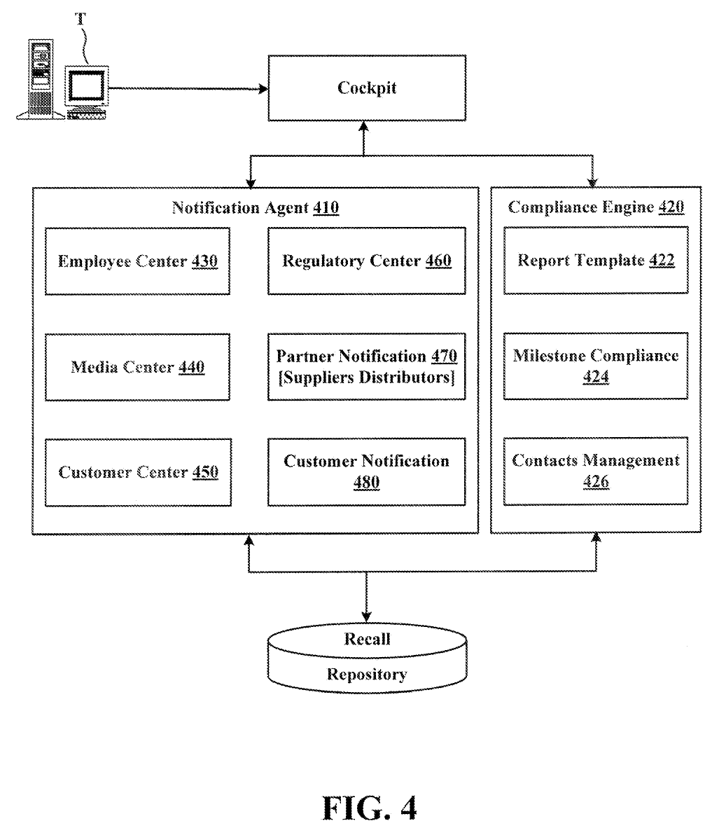

FIG. 4 is a functional block diagram of a notification system 400 according to an embodiment of the present invention. The notification system 400 may include a notification agent 410 and a compliance engine 420. The notification agent 410 may act as a data management center to organize and present data regarding an ongoing recall. As noted, the notification system 400 may tailor presentation of data to suit the needs of different audiences. Thus, the notification agent 410 may include modules 430-460 that maintain an ‘employee center,’ a ‘media center,’ a ‘customer center’ and a ‘regulatory center.’ When the cockpit opens a session with a new terminal T, the system may classify the terminal's operator and engage one of the centers as described above.

The notification agent 410 also may generate recall notifications proactively. For example, the RMS may be provided in a system that maintains records for partners in the distribution chain and perhaps even end consumers. When it is determined to launch a recall, partner notification units 470 and consumer notification units 480 may initiate communication with those partners and consumers. Commonly, partner databases and consumer databases store mailing addresses, e-mail addresses and/or telephone numbers for each contact. Partner and consumer notification units 470, 480 may engage other system (not shown) to generate automated notifications to those contacts. For example, the notification units 470, 480 may engage an e-mail server to transmit recall notifications by e-mail. Alternatively, the notification units 470, 480 may engage automated telephonic voice response systems to notify contacts telephonically.

Again, the partner and consumer notification units 470, 480 each mail tailor the presentation of the recall notification to suit the needs of the individual recipient. For example, a recall notification to an end consumer may include information regarding remediation of the defective product—procedures explaining how to replace or repair the product. A recall notification to a distributor by contrast may include information identifying which batches are likely to contain defects and which are not. From the notification, the distributor might be able to determine whether it holds any defective products in its inventory and withhold them from further distribution. It also could determine which products in its inventory are unlikely to contain the defects and can be distributed or sold.

Each of the modules 430-480 of the notification agent 410 may have access to the recall depository to gain access to substantive data regarding the recall and its progress.

In an embodiment, the notification system may include a compliance engine 420 to ensure compliance with regulatory agencies and the like during management of the recall. In many industries, firms are subject to specific requirements regarding the reporting of defective products. Indeed, many firms are required to submit product defect data to specific regulatory agencies in specific formats according to a predetermined timetable. The compliance engine 420 may manage this process in the RMS.

The compliance engine 420 may include modules that define regulatory reporting procedures to be undertaken. A report template unit 422 may identify the form and content of reports that are to be made. A milestone compliance unit 424 may identify when reports are to be made. A contacts management unit 426 may identify to whom the reports are to be made. During operation, the compliance engine 420 periodically refers to the milestone compliance unit 424 to determine whether a report has come due. If so, the compliance engine may refer to the report template to determine what data needs to be provided in the next report. The compliance unit may retrieve the required data from the recall repository and format the data according to parameters identified in the report template 422. The compliance unit may transmit the report to a recipient identified in the contact management unit 426.

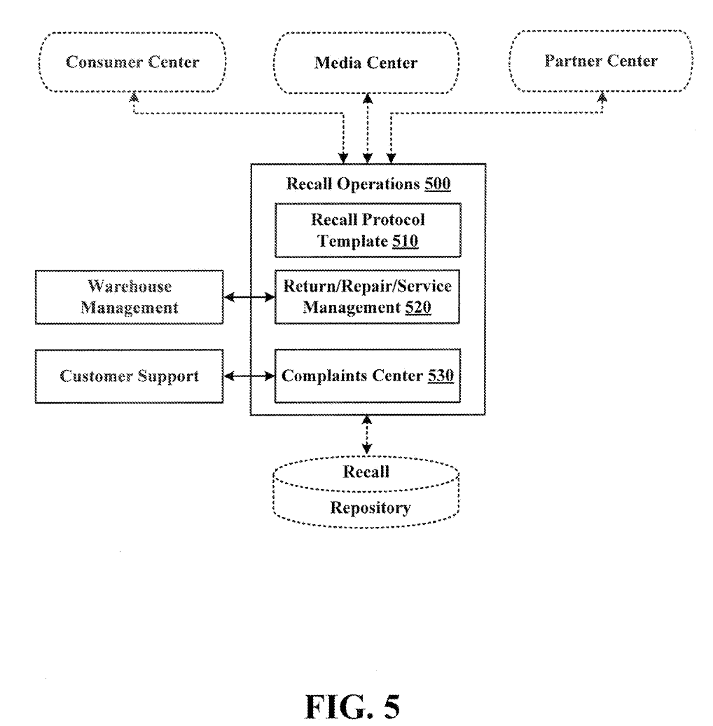

FIG. 5 is a functional block diagram of a recall operations module 500 according to an embodiment of the present invention. The recall operations module 500 provides support for the recall itself. It can help manage returns or service of distributed products that may include product defects. According to an embodiment, the recall operations module may include a recall protocol template 510, returns/repair/service management unit 520 and a complaints center 530. The recall protocol template 510 may provide a definition of recall procedures that govern recall of a given product. Intuitively, one may expect that recall procedures for automobiles may differ from recall procedures for other products, such as medications or office products. The recall protocol template 510 establishes how a recall of the defective product may occur.

A returns/repair/service management unit 520 may regulate the processes defined in the recall protocol template. For example, in the cause of an automobile defect where defective automobiles are to be submitted to service stations for repair, consumers or technicians may be required to obtain a pre-authorization before a manufacturer will agree to compensate the technician for remedial services. The returns/repair/service management unit 520 may authenticate a given automobile (for example, by verifying that the auto's vehicle identification number is subject to recall) and providing an electronic tracking number to the technician that authorizes the technician to perform remedial service pursuant to the recall.

The complaints center 530 may provide an automated process through which recall participants may voice concerns regarding the recall or its procedures. The complaints center 530 may establish a session with participants' terminals to collect feedback. Data from the participants may be stored in the recall repository for later use. Further, the return operations system 510 may engage a customer support center 540 to process the collected feedback. Customer support centers 540 conventionally are provided by product manufacturers and other firms as part of customer relationship management applications (colloquially, “CRM”) in enterprise management systems. Thus, the recall operations system 510 may be integrated with such CRM applications to facilitate the recall operations.

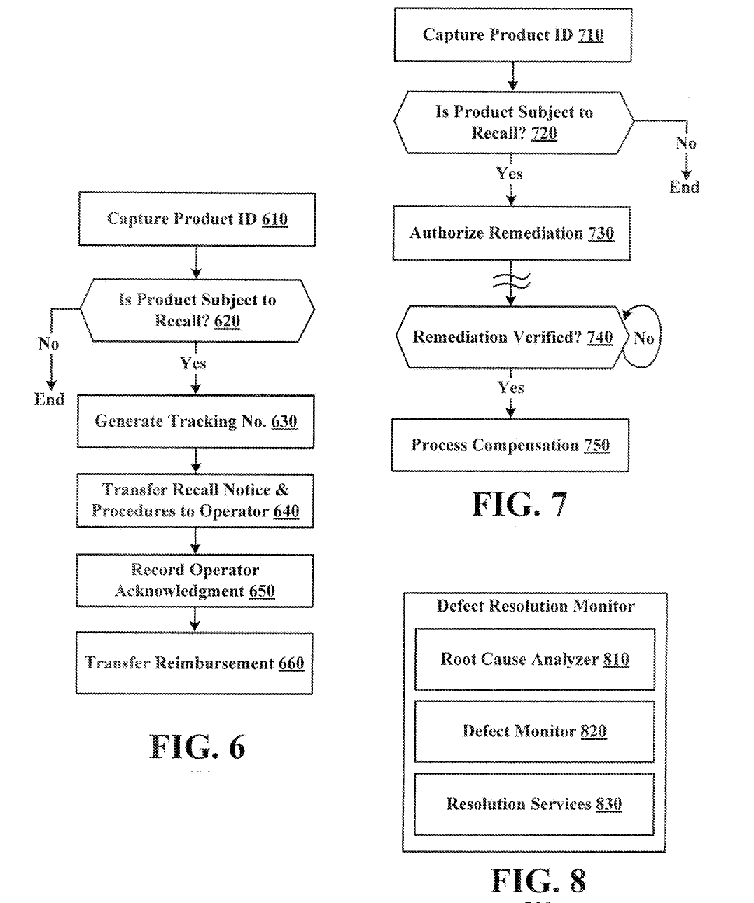

FIG. 6 is a flow diagram illustrating a procedure that may govern a product recall according to one embodiment of the present invention. The method may begin when a consumer establishes a session with the recall operations system 610 of FIG. 6. In the embodiment, the method may capture product identification information (box 610) and, with reference to recall repository, determine whether the consumer's product is subject to the recall (box 620). If so, the method may generate a tracking number for the recall (box 630). The method also may transfer to the consumer a notification of the procedures to be followed to repair or replace the product as well as information regarding what is known about the product's defects and possible consequences that may occur from continued use of the product (box 640). The method may require that the consumer acknowledge receipt of the notices and may record the consumer's acknowledgement in the recall repository (box 650).

In some embodiments, the recall procedures may compel customers to destroy the products they hold and purchase replacements. Thus, the recall operations system 610 may provide an electronic certificate to the consumer entitling the consumer to a free replacement product (box 660). In another embodiment, not shown, the recall operations system 610 may enter a transaction in a warehouse management system 550 (FIG. 5), which may cause a replacement product to be shipped to the consumer.

FIG. 7 illustrates a method 700 that may occur when a consumer presents a product at a repair facility for remediation according to an embodiment of the present invention. This embodiment may be appropriate when a service provider establishes a communication session with the recall operations system. According to the method, a system may capture product identification information (box 710) and determine whether the product is subject to a recall (box 720). If so, the method may signal to the service provider's terminal that remediation is authorized (box 730). Sometime thereafter, either during the same session or pursuant to another session, the service provider may indicate that the remediation has been performed. The method may engage verification procedures and, upon successful verification, may process compensation to the service provider (boxes 740, 750).

FIG. 8 is a block diagram of a defect resolution module 800 according to an embodiment of the present invention. The defect resolution module 800 provides a tool that can help an organization to revise their operations to guard against future occurrences of the product defect that gives rise to a recall. The defect resolution module 800 may include a root cause analyzer 810, a defect monitor 820 and a resolution services module 830.

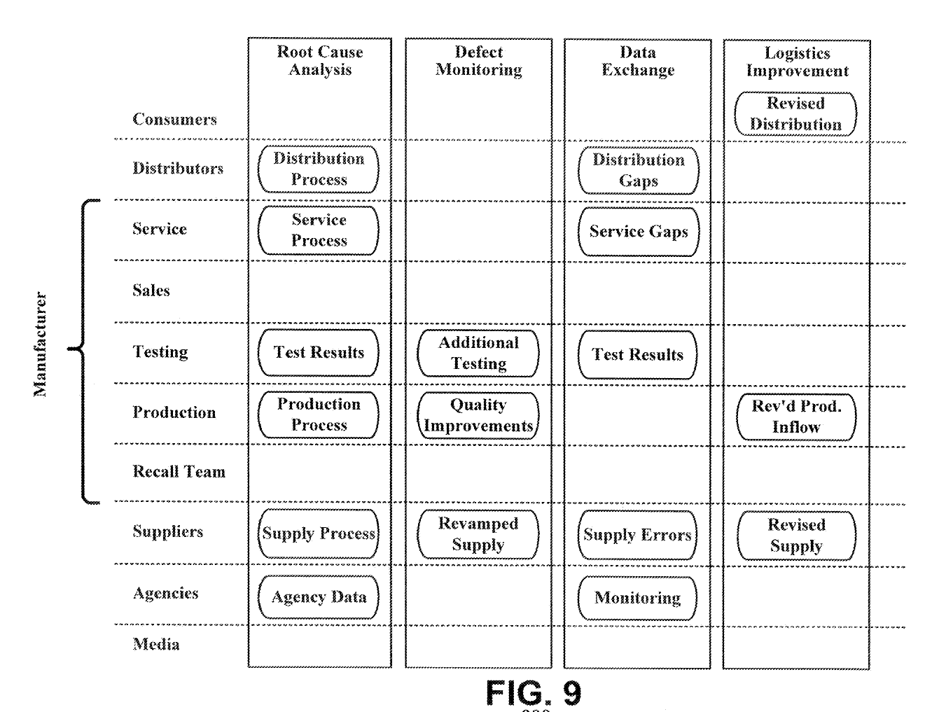

The root cause analyzer 810 provides a tool to identify a source of the defect within the operational framework of the organization. In so doing, the root cause analyzer 810 may gain access to much of the same data as the early warning system 200 (FIG. 2) and to the distribution modeling performed by that system. In the data flow diagram of FIG. 9, therefore, the root cause analyzer is shown having access to data sources from distributors, service personnel, manufacturing testing divisions and manufacturing production divisions, suppliers and agency sources. The root cause analyzer 810 can trace migration of a defective product or components through the distribution chain and identify likely sources of the defect.

The defect monitor 820 provides services to monitor production process and product testing facilities, both those that were in place prior in identification of a product defect and those that may be initiated in response to the defect. Even if the root analyzer cannot identify a single likely source of a product defect, the defect monitor 820 may gather data regarding component and product performance and testing data therefor.

The resolution services module 830 provides a feedback path from the data harvesting functions of the root cause analyzer 810 and the defect monitor 820 to the operations of the organization and its relationships perhaps with other entities in the distribution chain. As such, the resolution services module 830 may include a first component to provide data exchange services with other members of the distribution chain and the public (e.g., distributors, suppliers, service technicians and governmental agencies). The resolution services module 830 also may include a component to identify processes within the distribution chain that are operating outside of defined operating requirements. For example, if the organization determined as a result of the recall analysis that delivery timetables for distributors must meet a predetermined schedule and the actual delivery timetables were longer than required, the resolution services module would report these failures both within the organization as well as to the distributors that are not performing adequately. Thus the defect resolution services module 800 can initiate remedial action based on data it collects regarding performance of the distribution chain. If a part from a parts manufacturer is defective, the RSM 830 is activated to track the performance of the improved product or to procure the part from other suppliers with performance feedback and required parts data exchange.

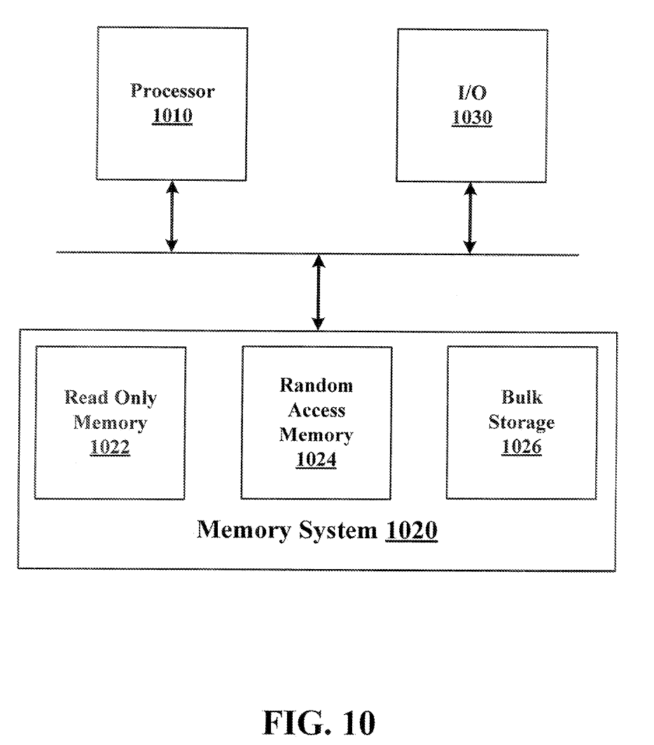

The foregoing embodiments may provide a software-implemented system. As such, these embodiments may be represented by program instructions that are to be executed by a server or other common computing platform. One such platform 1000 is illustrated in the simplified block diagram of FIG. 10. There, the platform 1000 is shown as being populated by a processor 1010, a memory system 1020 and an input/output (I/O) unit 1030. The processor 1010 may be any of a plurality of conventional processing systems, including microprocessors, digital signal processors and field programmable logic arrays. In some applications, it may be advantageous to provide multiple processors (not shown) in the platform 1000. The processor(s) 1010 execute program instructions stored in the memory circuits. The memory system 1020 may include any combination of conventional memory circuits, including electrical, magnetic or optical memory systems. As shown in FIG. 10, the memory system may include read only memories 1022, random access memories 1024 and bulk storage 1027. The memory system not only stores the program instructions representing the various methods described herein but also can store the data items on which these methods operate. The I/O unit 1030 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1-19. (canceled)

20. A computerized recall management system, comprising:
a communications system to facilitate communications regarding a product defect, comprising:
a data harvesting agent to receive product performance data for a product in a product distribution chain;
a product defect data solicitation unit to solicit product defect data from product distribution chain sources upon detection of the product defect;
a recall reporting system, storing a plurality of reporting templates representing recall reporting requirements, to generate a plurality of recall reports for a plurality of external entities from stored recall repository data and solicited product defect data according to parameters defined in the reporting templates, wherein each report to each external entity is unique; and
a recall notification system to generate and transmit recall notifications to entities affected by the product defect, wherein each recall notification to each affected entity is unique;
an early warning and assessment system to analyze the received product performance data received from the product distribution chain sources and detect product defect patterns from the received product performance data;
a recall repository to store product performance data identifying product defects, recall operations data representing performance of the recall, and recall performance data to be included in the plurality of recall reports; and
a recall operations system to manage recall operations of a product subject to a recall.

21. The recall management system of claim 20, wherein the recall notification system classifies each affected entity to which it communicates based on actions to be taken by the affected entity and communicates with the respective affected entity in a manner that is specific to the classification applied thereto.

22. The recall management system of claim 21, wherein the affected entities are classified into one of the following groups: customers, media, partners and regulators.

23. The recall management system of claim 20, wherein the recall reporting system formats the reports according to the reporting requirements of the intended external entity and transmits the reports according to a predetermined timetable set by the intended external entity.

24. The recall management system of claim 23, wherein the external entities are regulatory agencies.

25. The recall management system of claim 20, wherein the early warning and assessment system comprises:
a defect processing agent to analyze the collected product performance data relative to product performance benchmarks and identify known and unknown product defects based on the analysis, wherein in response to an identified unknown product defect, the defect processing agent generates an alert; and
a defect classification agent to compare a frequency of occurrence of the known product defect within a product line to allowable statistical limits in response to an identified known product defect, wherein if the frequency is greater than the allowable statistical limits, the defect classification agent generates an alert.

26. The recall management system of claim 23, wherein responsive to the generated alert, the early warning and assessment system is further to perform product distribution modeling to determine an extent to which defect products have propagated through the product distribution chain.

27. The recall management system of claim 20, wherein the recall operations system comprises:
a recall protocol template to provide recall procedures that govern the recall of the defective product;
a service management unit, responsive to a return of an allegedly defective product, to verify the allegedly defective product is subject to the recall and to authorize performance of the recall procedures: and
an automated customer service center to receive feedback and complaints related to the recall or the recall procedures from recall participants.

28. The recall management system of claim 20, wherein the product distribution chain sources are suppliers, manufacturers, distributors, and consumers.

29. The recall management system of claim 20, wherein the data harvesting agent receives the product performance data from suppliers, manufacturers, distributors, and consumers.

30. The recall management system of claim 20, wherein the data harvesting agent receives the product performance data from testing systems and quality control systems internal to a manufacturer of the product.

31. The recall management system of claim 20, wherein the data harvesting agent receives the product performance data from testing systems external to a manufacturer of the product and governmental agencies.
